(19) United States
(12) Patent Application Publication
(10) Pub. No.: US 2025/0230325 A1
(43) Pub. Date: Jul. 17, 2025

(54) REPELLENT COATING FORMULATION WITH LOW VOLATILE ORGANIC COMPOUNDS

(71) Applicant: SPOTLESS MATERIALS INC., STATE COLLEGE, PA (US)

(72) Inventors: Nan SUN, State College, PA (US); Frank V. CONSTANTINE, JR., State College, PA (US); Birgitt BOSCHITSCH, State College, PA (US); Tak-Sing WONG, State College, PA (US)

(21) Appl. No.: 19/076,271

(22) Filed: Mar. 11, 2025

Related U.S. Application Data
(63) Continuation of application No. PCT/US2023/074882, filed on Sep. 22, 2023.
(60) Provisional application No. 63/409,530, filed on Sep. 23, 2022.

(51) Int. Cl. C09D 5/16; B01L 3/00; C08G 77/18; C09D 183/06

(52) U.S. Cl. CPC C09D 5/1675; B01L 3/502707; C08G 77/18; C09D 183/06; B01L 2300/165

(57) ABSTRACT

Formulations for preparing repellent coatings on surfaces of substrates and having low volatile organic compound solvents are disclosed. Such formulations include (i) one or more reactive components that can form a bonded layer on the surface; (ii) an acid catalyst; and (iii) a lubricant. Such formulations can be applied to one or more surfaces of medical devices and one or more surfaces of microfluidic devices, for example, and can resist fouling thereof.

### CROSS-REFERENCE TO RELATED APPLICATIONS

This application is a continuation of International Patent Application No. PCT/US2023/074882, filed on Sep. 22, 2023, which claims priority to U.S. Provisional Patent Application No. 63/409,530 filed Sep. 23, 2022, the disclosures of which are incorporated by reference in their entireties.

### STATEMENT REGARDING FEDERALLY SPONSORED RESEARCH

This invention was made with government support under Contract No. 2026140 awarded by the National Science Foundation. The government has certain rights in the invention.

### TECHNICAL FIELD

The present disclosure relates to formulations that can form repellent and antifouling coatings on surfaces of substrates such as on the surfaces of electronic devices and in some implementations the formulations have a low concentration of solvents, if any, that are volatile organic compounds.

### BACKGROUND

Repellent coating formulations are known. See for example, Wang, et al., “Covalently Attached Liquids: Instant Omniphobic Surfaces with Unprecedented Repellency”, Angewandte Chemie International Edition 55, 244-248 (2016); WO 2018/094161; WO 2019/222007; WO 2021/051036; and WO 2022/197757.

However, there is a continuing need to develop formulations to form repellent surface coatings that are simple to apply and environmentally acceptable with a sufficient shelf-life and that can further resist fouling.

### SUMMARY OF THE DISCLOSURE

Advantages of the present disclosure include formulations having low concentration of solvents that are volatile organic compounds. The formulations of the present disclosure can be used to prepare repellent coatings for a wide range of solid surfaces including those composed of one or more polymers, ceramics, glasses, glass-ceramics, porcelains, metals, alloys, composites, or combinations thereof.

These and other advantages are satisfied, at least in part, by a formulation comprising: (i) one or more reactive components that can form a bonded layer on a surface; (ii) an acid catalyst; and (iii) a lubricant. Useful lubricants include silicone oils or mineral oils or plant oils or any combination thereof. Advantageously, the lubricant has a viscosity of no less than 2 cSt at 25° C., e.g., no less than about 5 cSt at 25° C. The lubricant can be included in the formulation in an amount of more than 50 weight percent (wt %), e.g., more than 60 wt %, 70 wt %, 80 wt %, 90%, etc., based on the total weight of the formulation. By including the lubricant in such a high concentration or higher, the formulation advantageously can be substantially free of solvents, diluents or carriers.

The formulation of the present disclosure advantageously can have a long shelf-life without substantial deactivation of the reactive components when stored around room conditions in closed containers. For example, formulations of the present disclosure can have a stable shelf-life of at least 1 month, such as at least 2, 3, 4, 5, 6, 9, 12 months etc. A stable shelf-life for a storage period can be determined by measuring a sliding angle of a surface of a glass slide having a repellent coating formed from a given formulation at the end of the storage period in which the formulation is stored in a sealed container and the average sliding angle is no more than 35 degrees for a 20 μL water droplet when measured at 20° C. The formulations of the present disclosure can advantageously have a closed cup flash point of more than about 38° C., 50° C., 60° C., 70° C., 80° C., 90° C. or even more than about 100° C. In addition, formulations of the present application can have a low VOC level by reducing or excluding volatile organic compound solvents such as reducing any VOC solvents to less than 10 wt %, e.g., less than about 5 wt % or less.

An additional advantage of the present disclosure includes a process of forming a repellent coating on a surface from the formulations disclosed herein. The process includes applying a formulation disclosed herein on a surface of a substrate to form a bonded layer on the surface and to form a lubricant layer stably adhered to the bonded layer formed from the lubricant. In some implementations, the substrate surface can be exposed/treated with an oxygen or air plasma to generate hydroxyl groups on the surface of the substrate followed by applying the formulation on the surface to form the repellent coating on the surface and/or an adhesion layer can be formed on the substrate surface followed by forming the repellent coating on the adhesion layer.

The repellent coating can be formed on a wide variety of surface compositions such as plastic, ceramic, glass, semiconductors, metals and alloys thereof and on a variety of fixtures and devices such as in metal plumbing fixtures, bathroom fixtures such as toilets, urinals, sinks, showers, surfaces of glass substrates including mirrors, windshields, windows, camera lenses, surfaces of polymers including medical devices such as ostomy appliances, catheters, etc. and electrical and electronic devices. In addition, the repellent coating can be formed on devices that are subject to high temperature cycles such as surfaces of induction and radiant cooktops and stoves and other cooking surfaces, ovens as well as tanks, containers, heat exchangers, such as heat exchangers for processing foods and beverages, etc. Such surface can be composed of one or more ceramics, glasses, glass-ceramics, porcelains, metals, alloys, composites or combinations thereof.

In one or more implementations, a medical device can include a repellent coating of the present disclosure on one or surfaces thereof. Such a medical device can include an ostomy appliance, catheter, contact lens, syringe, scalpel, endoscope lens, a metal and/or plastic implant, prostheses, etc.

In other implementations, a microfluidic device, such as a microfluidic device configured to process a sample of biological fluid, can include a repellent coating of the present disclosure on one or more surfaces thereof. For example, a microfluidic device having a substrate surface can include a repellent coating thereon wherein the repellent coating includes a layer bonded on the surface, a lubricant layer on the bonded layer. Such substrate surfaces can be one or more of an electrically conductive surface such as an electrode surface, a dielectric layer surface, and/or and insulating layer surface. In some implementations, the repellent coating on such surfaces can have a thickness of greater than 1 micron such as greater than 5 microns.

Additional advantages of the present invention will become readily apparent to those skilled in this art from the following detailed description, wherein only the preferred embodiment of the invention is shown and described, simply by way of illustration of the best mode contemplated of carrying out the invention. As will be realized, the invention is capable of other and different embodiments, and its several details are capable of modifications in various obvious respects, all without departing from the invention. Accordingly, the drawings and description are to be regarded as illustrative in nature, and not as restrictive.

### BRIEF DESCRIPTION OF THE DRAWINGS

Reference is made to the attached drawings, wherein elements having the same reference numeral designations represent similar elements throughout and wherein:

FIG. 1 is schematic illustrating the preparation of a repellent coating in accordance with one or more implementations of the present disclosure.

FIG. 2 is another schematic illustrating the preparation of a repellent coating in accordance with one or more implementations of the present disclosure.

FIGS. 3A and 3B illustrate a repellent coating on microfluidic devices in accordance with one or more implementations of the present disclosure.

FIG. 4 illustrates a plot of adhesion layer thickness to reactive component concentration.

FIGS. 5A and 5B illustrate comparative wetting characteristics of surfaces that are uncoated and coated with a repellent coating in accordance with one or more implementations of the present disclosure. The wetting characteristics were determined from a water droplet in a mineral oil medium.

FIG. 6 illustrates comparative data showing protein fouling for an uncoated substrate, and a substrate having a repellent coating in accordance with one or more implementations of the present disclosure. The arrows in the figure signify the reduction in fouling of the substrate having the repellent coating relative to the uncoated substrate.

### DETAILED DESCRIPTION OF THE DISCLOSURE

The present disclosure relates to formulations that can form repellent coatings on a variety of substrates with low volatile organic compound solvents, such as less than 10 wt %, e.g., less than about 5 wt % or less. Formulation of the present disclosure include reactive component(s), an acid catalyst, and a lubricant. The reactive components can form a bonded layer on a surface of a substrate with the acid catalyst and the lubricant forms a lubricant layer on and between the bonded layer. The bonded layer and lubricant layer together form the repellent coating.

However, formulations of the present disclosure use an excess amount of lubricant needed to form the repellent coating. Advantageously, excess lubricant can substitute for a solvent, diluent, or carrier fluid in the formulation. Hence, the lubricant can serve the dual role of carrier fluid and forming a lubricant layer on the bonded layer to form the repellent coating. Lubricants of the present disclosure further advantageously can have low vapor pressure and thus do not add to the volatility of the formulation. The lubricant can be included in the formulation, based on the total weight of the formulation, in an amount of more than 50 wt %, such as at least 60 wt %, 70 wt %, 80 wt %, 90 wt %, 95 wt % and even up to 99 wt % lubricant. After the repellent coating is formed, excess lubricant can be removed from the repellent coating while still leaving a lubricant layer on and between the bonded layer.

The formulation of the present disclosure can include other components such as a fragrance, stabilizers, emulsifiers, inhibitors, etc. in a small amount, such as no more than about 10 wt %, 5 wt % and even 2 wt % or 1 wt % or less, based on the total weight of the formulation. The formulation can also include water such as less than 50 wt % based on the total weight of the formulation, such as no more than about 25 wt %, 15 wt %, 10 wt %, 5 wt % and even 2 wt % or less, based on the total weight of the formulation.

Further, other than potentially the reactive components, the formulations of the present disclosure do not include a substantial amount of volatile organic compounds. Volatile organic compounds (VOCs), as defined by the U.S. Environmental Protection Agency and adopted herein, include any compound of carbon, excluding carbon monoxide, carbon dioxide, carbonic acid, metallic carbides or carbonates, and ammonium carbonate, which participates in atmospheric photochemical reactions. Such VOCs include, for example, ethanol, isopropanol, hexane, benzene, toluene, xylene, chloroform, formaldehyde. Such VOCs are preferably not included in the formulation in an amount of more than about 10 wt %, e.g., less than about 5 wt %, 3 wt %, and less than about 1 wt % or at a level of an impurity, if at all.

Preferably, any additional component of the formulation should have a relatively high closed-cup flash point to reduce the flammability of the overall formulation. Specifically, flammable liquids are classified by the National Fire Protection Association (NFPA) as Class I with flash points below 100° F. (37.8° C.); whereas combustible liquids are classified as Class II and Class III with flash points in between 100° F. (37.8° C.) and 200° F. (93° C.). In an aspect, the formulations of the present disclosure can have a closed-cup flash point of more than about 38° C., such as more than about 40° C., 50° C., 60° C., 80° C., 90° C. and even a closed-cup flash point of more than about 100° C. In an embodiment, formulations of the present disclosure can have a closed cup flash point of from about 38° C. to about 210° C., e.g., from about 40° C. to about 180° C. For example, dodecamethylpentasiloxane (a silicone lubricant) has a viscosity of 2 cSt (at 25° C.) and has closed cup flash point of about 75° C. Polydimethylsiloxane (PDMS) having a viscosity of 5 cSt (at 25° C.) has a closed-cup flash point of about 135° C. and PDMS 20 cSt has a closed-cup flash point of about 232° C. Flash points of individual components and complete formulations of the present disclosure can be measured by ASTM D93 Closed Cup Flash Point protocol or an equivalent protocol.

In certain embodiments, the concentrations of various components on a weight bases in formulations of the present disclosure can include the ranges provided in Table A below:

TABLE A
Low VOC Solvent Formulations

| | First Approximate | Second Approximate |
|---|---|---|
| Component | Concentration Range | Concentration Range |
| Reactive component | 0.1-20 wt % | 0.5 -10 wt % |
| Acid Catalyst | 0.01-10 wt % | 0.5-5 wt % |
| Lubricant | 50 wt %-99 wt % | 80 wt %-99 wt % |
| Other | 0%-less than 50 wt % | 0-5 wt % |

Advantageously, the formulation of the present disclosure can have a long shelf-life without substantial deactivation of the reactive components when stored around room conditions in closed containers. Shelf life is determined by forming a repellant coating from the formulation on a glass slide after the formulation has been stored in a sealed container at the end of the storage period. A formulation having a stable shelf life for the storage period is one in which an average sliding angle of the surface having the repellent coating formed from the formulation is no more than 35 degrees for a 20 μL water droplet when measured at 20° C. at the end of the period. Such an average sliding angle can be determined by three independent measurements. It may be helpful to also determine any change in the stability of the formulation, which can be carried out by determining the sliding angle when the formulation is initially prepared and again after a certain storage period. In some aspects, formulations of the present disclosure can have a stable shelf-life of at least 1 month, such as at least 2, 3, 4, 5, 6, 9, 12 months etc.

Repellent coatings on surfaces of substrates as disclosed herein can be thermally stable such that the repellent coating on the surface of the substrate can be maintained at a temperature of above 100° C., e.g., above 100° C. to about 300° C., for at least 10 minutes, such as at least 20 minutes, 30 minutes, etc. For example, the surface having the repellent coating can have an average sliding angle for a 20 μL water droplet of no more than about 35°, such as no more than about 30°, 25°, 20°, etc. and even less than about 10° when measured at 20° C., after repeated high temperature cycling.

Repellent coatings on surfaces of substrates as disclosed herein can be formed from a formulation that includes: (i) reactive component(s) to form the bonded layer on a surface of a substrate; (ii) acid catalyst(s); and (iii) lubricant(s). The reactive component(s) of the formulation are used to form the bonded layer onto the surface of a substrate by allowing them to react with the surface. Advantageously, the reactive components can form an array of compounds on the surface in which each compound has one end covalently bound to the surface and an opposite end extending away from the surface. As such, the bonded layer resembles a brush with linear chains bound to the surface. The acid catalyst facilitates and accelerate formation of the bonding layer at a reduced time and temperature. Sufficient reactive component(s) and acid are needed to form an effective bonded layer. The lubricant can form a lubricant layer to stably adhere to the bonded layer primarily through van der Waals interactions to enhance the repellency and antifouling characteristics of the coating. Such a formulation can form a repellent coating comprising a bonded layer with a lubricant layer stably adhered to the bonded layer as an all-in-one formulation. Excess lubricant in the formulation can be removed from the surface such as by washing or wiping, or through gravity drainage, or cleaned by alcohols.

The bonded layer can be formed directly or indirectly on a surface of a substrate by reacting the reactive components of the formulation directly with functional groups, e.g. hydroxyl groups, acid groups, ester groups, etc., which are on the surface of the substrate. Such functional groups can be naturally present or induced on the substrate such as by treating the surface with strong oxidizers, or an oxygen or air plasma, or a corona discharge, or by heating the substrate under the presence of air or oxygen, etc. or any combination thereof.

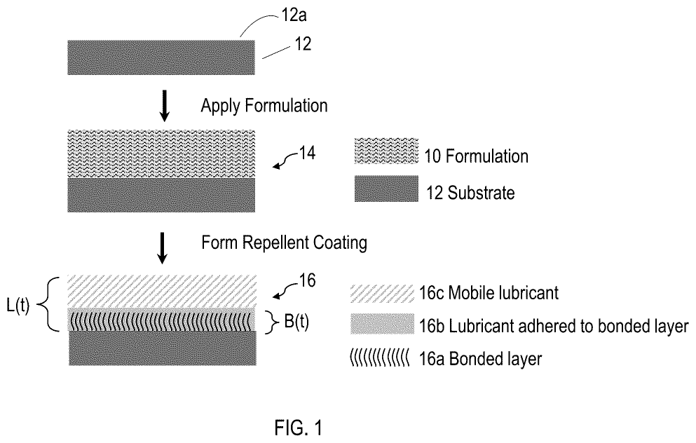

FIG. 1 illustrates a process of forming a repellent coating (16) on a surface of a substrate in accordance with an implementation of the present disclosure. For this example, a formulation (10) of the present disclosure is applied to a surface (12a) of a substrate (12) to form a substrate with the formulation coating on its surface (14). The reactive components of the formulation react with the surface of the substrate (12a) to form a bonded layer (16a) covalently bound to the surface (12a). The lubricant in formulation (10) forms a lubricant layer (16b) on and within the bonded layer (16a). Additional, e.g., excess or non-adhered, lubricant (16c) remains over the bonded layer. Such excess lubricant is more mobile compared to the lubricant within the boned layer. In some implementations, the excess, non-adhered lubricant can be removed, if desired, by washing or wiping, or through gravity draining, or by cleaning with an alcohol, e.g., isopropanol.

The thickness (B(t)) of the bonded layer 16a will depend on the concentration of reactive components and type of reactive components in the formulation. In some implementations, the bonded layer can have a thickness of up to about 1000 nm. In some aspects, the thickness of the bonded layer can be up to about 500 nm, up to about 100 nm, about 50 nm, or up to about 20 nm, e.g. from about 1, 5, 10 nm to about 1000 nm.

The thickness (L(t)) of the lubricant layer (16b and 16c) can be estimated based on the weight percent of lubricant in the formulation, the density of the lubricant, the total applied mass of the formulation, and the total surface area of the substrate wetted by the formulation assuming the weight percentage of lubricant dominates in the formulation (e.g., weight percent of lubricant exceeds 90%). For example, a 10-gram formulation with 90% weight percent of lubricant at a density of about 1 g/cm³ and covering a wetted surface area of 100×100 cm² applied would yield a lubricant thickness of approximately 9 microns. When the formulation includes more volatile components, a lubricant thickness can be estimated by measuring the weight of an applied formulation before and after removing the volatile components and then estimating the lubricant thickness based the mass and density of the lubricant and applied surface area. The lubricant thickness on the surface can be adjusted by adjusting the concentration of lubricant in the formulation and the applied mass of the formulation on the substrate given a known applied surface area. In some implementations, the thickness of the lubricant can be at least the thickness of the bonded layer and more such as up to about 0.1 microns, and higher, e.g., up to 0.2, 0.3, 0.4, 0.5, 0.6, 0.7, 0.8, 0.9, 1, 2, 4, 5, 6, 7, 8, 9, 10, 15, 20, 30, 40, 50 microns or more. However, when the thickness of the lubricant is too high, the lubricant may drain off the substrate surface unless it is contained on the surface.

Reactive components for formulations of the present disclosure include, for example, reactive components that have one end that bonds to the substrate surface, e.g., covalently bonds to one or more reactive groups on the surface, to form an assembly of compounds. Such reactive components preferably have a chain length of at least 3 carbons. Other useful reactive components include polymerizable monomers that can react to form an array of linear polymers having ends anchored to the surface and opposite ends extending away from the surface. To increase the speed of forming a repellent coating, the reactive components of the formulation are selected to undergo a condensation reaction with loss of a small molecule such as water, an alcohol, etc. which can be readily removed to drive the reaction to more or less completion under ambient temperatures and pressures. Preferably linear polymers, with one end attached to the surface and the other extending away from the surface, do not form covalent bonds with the adjacent linear polymers or crosslink, such as crosslinks with the adjacent linear polymers (e.g., the linear polymers form a brush-like structure). A lack of crosslinking allows the chains and ends extending away from the surface higher mobility to further enhance the repellency of the repellent coating.

Useful reactive components for formulations of the present disclosure include, for example, low molecular weight silanes or siloxanes that have one or more hydrolysable groups. Such silanes or siloxanes have a molecular weight of less than about 1,500 g/mol such as less than about 1,000 g/mol and include a monoalkyl or mono-fluoroalkyl phosphonic acid such as 1H,1H,2H,2H-perfluorooctane phosphonic acid, an alkoxysilane such as a mono-alkoxy silane, e.g., an alkyl, fluoroalkyl and perfluoroalkyl mono-alkoxy silane, trimethylmethoxysilane; a di-alkoxy silane, e.g., a dialkyl di-alkoxy silane, such as a C₁₋₈ dialkyldialkoxy silane e.g., dimethyldimethoxysilane, dimethoxy(methyl)octylsilane, diethoxydimethylsilane, diethyldiethoxysilane, diisopropyldimethoxysilane, di-n-butyldimethoxysilane, diisobutyldimethoxysilane, diisobutyldiethoxysilane, isobutylisopropyldimethoxysilane, dicyclopentyldimethoxysilane, a di-alkoxy, diphenyl silane, e.g., dimethoxydiphenylsilane, diphenyldiethoxysilane, a di-alkoxy, fluoroalkyl silane or perfluoroalkyl silane, dimethoxy-methyl(3,3,3-trifluoropropyl)silane, (3,3,3-trifluoropropyl)methyldimethoxysilane, a alkyltrimethoxysilane, a tri-alkoxy silane, e.g., a perfluoroalkyl-tri-alkoxy silane, trimethoxy (3,3,3-trifluoropropyl)silane, trimethoxymethylsilane, 1H,1H,2H,2H-perfluorodecyltrimethoxysilane, 1H,1H,2H,2H-perfluorodecyltriethoxysilane, nonafluorohexyltrimethoxysilane, nonafluorohexyltriethoxysilane, (tridecafluoro-1,1,2,2-tetrahydrooctyl)trimethoxysilane, tridecafluoro-1,1,2,2-tetrahydrooctyl)triethoxysilane, heptadecafluoro-1,1,2,2-tetrahydrodecyl)trimethoxysilane, (heptadecafluoro-1,1,2,2-tetrahydrodecyl)triethoxysilane, a chlorosilane, e.g., octyldimethylchlorosilane, a dichlorosilane, e.g., diethyldichlorosilane, di-n-butyldichlorosilane, diisopropyldichlorosilane, dicyclopentyldichlorosilane, di-n-hexyldichlorosilane, dicyclohexyldichlorosilane, di-n-octyldichlorosilane, 3,3,3-trifluoropropyl)methyldichlorosilane, nonafluorohexylmethyldichlorosilane, (tridecafluoro-1,1,2,2-tetrahydrooctyl)methyldichlorosilane, (heptadecafluoro-1,1,2,2-tetrahydrodecyl)methldichlorosilane, (3,3,3-trifluoropropyl)dimethylchlorosilane, nonafluorohexyldimethylchlorosilane, tridecafluoro-1,1,2,2-(heptadecafluoro-1,1,2,2-tetrahydrooctyl)dimethylchlorosilane, tetrahydrodecyl)dimethylchlorosilane, a trichlorosilane, e.g., (tridecafluoro-1,1,2,2-tetrahydrooctyl)trichlorosilane, (3,3,3-trifluoropropyl)trichlorosilane, nonafluorohexyltrichlorosilane, (heptadecafluoro-1,1,2,2-tetrahydrodecyl)trichlorosilane, an amino silane, e.g., nonafluorohexyltris(dimethyamino)silane, etc.

The alkoxy groups of such reactive components can be C₁₋₄ alkoxy groups such as methoxy (—OCH₃), ethoxy (—OCH₂CH₃) groups and the alkyl groups of such reactive components can have various chain lengths, e.g., of C₁₋₃₀, such as C₃₋₃₀. The alkyl groups of such reactive components that form linear polymers generally have a lower alkyl group, e.g., C₁₋₁₆, such as C₁₋₈. The alkyl groups in each case can be substituted with one or more fluoro groups forming fluoroalkyl and perfluoroalkyl groups of C₁₋₃₀, C₃₋₃₀, C₁₋₁₆, C₁₋₈, etc. chains such as a fluoroalkyl or perfluoroalkyl alkoxysilane, a difluoroalkyl or diperfluoroalkyl di-alkoxy silane, a fluoroalkyl or perfluoroalkyl tri-alkoxy silane having such chain lengths.

The bonded layer can be formed from the formulation by reacting the reactive components of the formulations directly with exposed hydroxyl groups or other reactive groups on the surface of a substrate to form an array of linear compounds having one end covalently bound directly to the surface through the hydroxyl groups or other reactive groups on the surface of a substrate. Alternatively, the bonded layer can be formed by polymerizing one or more of a silane monomer directly from exposed hydroxyl groups or other reactive groups on the surface of a substrate to form an array of linear polysilanes or polysiloxanes or a combination thereof covalently bound directly to the surface through the hydroxyl groups or other reactive groups on the surface of a substrate. Preferably the linear polymers, with one end attached to the surface and the other extending away from the surface, do not form covalent bonds or crosslink with the neighboring linear polymers (e.g., the linear polymers form brush-like structures).

One or more acid catalysts can be included in the formulations of the present disclosure. As used herein a catalyst refers to one or more catalysts. A catalyst can facilitate and accelerate formation of the bonding layer. Acid catalysts that can be included in the formulation include an acid having a pKa of less than about 3 since these acids tend to facilitate rapid formation of the bonding layer. Such acids catalysts, include for example, as sulfuric acid, hydrochloric acid, phosphoric acid, nitric acid, etc. or combinations thereof. In some embodiments, the catalyst does not include a catalyst containing a transition metal such as platinum since such catalysts tend to increase costs and remain in the formed coating.

The formulation of the present disclosure also includes a lubricant or combination of lubricants, collectively referred to herein as a lubricant. The lubricant is in excess in the formulation and preferably forms a lubricant layer over and between the bonding layer. The lubricant layer preferably is stably adhered to the bonded layer. To form a stably adhered lubricant layer to a bonded layer which in turn is formed from the reactive components of the formulation, a lubricant should have strong affinity to the bonded layer and/or the substrate so that the lubricant can fully wet the surface (e.g., result in an equilibrium contact angle of less than about 5°, such as less than about 3°, about 2°, or less than about 1°, or about 0°) and stably adhere on the surface. Further, since certain surfaces of substrates and repellent coating thereon can be subjected to temperatures above 100° C., the lubricant preferably has a low vapor pressure under atmospheric pressure. In addition, the lubricant should be mobile in the formed repellent coating and thus it is preferable that the lubricant not substantially react, if at all, with the reactive components in the formulation. A stably adhered lubricant to the bonded layer is believed due primarily to van der Waals forces, not through covalent bonding to the bonding layer. In certain embodiments, lubricants for the present disclosure do not have groups that would react with the reactive components of the formulation.

A lubricant useful for formulations and repellent coatings of the present disclosure should have a sufficient viscosity yet be relatively mobile to facilitate repellence of the coating system at temperatures intended for use with the substrate having the repellent coating. Such temperatures can range from about −50° C. to about 300° C. In addition, the surface of the substrate and repellent coating thereon can be subjected to high temperature cycling of above and below 100° C. and the cycle repeated multiple times. As such, a lubricant should preferably have a viscosity of at least about 2 cSt (as measured at 25° C.) such as at least about 3 cSt, 5 cSt, 6 cSt, 7 cSt, 8 cSt, 9 cSt, 10 cSt, 15 cSt, 20 cSt, 30 cSt, 40 cSt, 50 cSt, 100 cSt, 200 cSt, 350 cSt etc. and any value therebetween. Further, so that the lubricant can be mobile at certain temperatures in which the repellent coating can be used, a lubricant should preferably have a viscosity of no more than about 1,500 cSt as measured at 25° C., such as no more than about 1,200 cSt, 1,100 cSt, 1,000 cSt, 900 cSt, 850 cSt, etc., as measured at 25° C., and any value therebetween. In an embodiment, a lubricant for a formulation of the present disclosure can have viscosity ranging from about 5 cSt to about 1500 cSt, such as from about 2 cSt, 5 cSt, 6 cSt, 7 cSt, 8 cSt, 9 cSt, 10 cSt, 15 cSt, 20 cSt, 30 cSt, 50 cSt, 100 cSt, etc. to about 1500 cSt, 1200 cSt, 1000 cSt, 800 cSt, 500 cSt, 350 cSt, 200 cSt, 150 cSt, etc., as measured at 25° C., and any value therebetween. For high temperature uses, the repellent coating can have a lubricant with an even higher viscosity at 25° C. since the viscosity of such a lubricant would be less at the higher use temperature. Further, lubricant densities of less than about 2 g/cm³ would be preferable at temperature range from 15° C. to 25° C.

A lubricant included in the formulation of the present disclosure can be one or more of an omniphobic lubricant, a hydrophobic lubricant and/or a hydrophilic lubricant. The lubricant can include a fluorinated oil or a silicone oil (such as food grade silicone oil) or a mineral oil or a plant oil. Other lubricants that can be used include fluorinated or perfluoropolyether, perfluoroalkylamine, perfluoroalkylsulfide, perfluoroalkylsulfoxide, perfluoroalkylether, perfluorocycloether oils and perfluoroalkylphosphine and perfluoroalkylphosphineoxide oils as well as mixtures thereof. Preferable, the lubricant is chosen to have a strong chemical affinity to the particular bonding layer and/or substrate so that the lubricant can fully wet and stably adhere to the surface via the bonding layer. For example, perfluorinated oils such as a perfluoropolyether (e.g., Krytox oil) can fully wet and stably adhere to a polymeric siloxane and/or silane bonding layer including fluorinated alkyl silanes such as perfluorinated alkyl silanes. Such a bonding layer can be formed from reactive fluoroalkyl silanes in a formulation that reacts with functional groups on a surface of a substrate. A silicone oil or plant oil can fully wet and stably adhere to a bonded layer comprised of an array of linear polydimethylsiloxane (PDMS), for example. Hydroxy polydimethylsiloxane can also fully wet and stably adhere to a bonded layer comprised of an array of linear polydimethylsiloxane (PDMS), for example, but a hydroxy polydimethylsiloxane lubricant would preferably be applied separately from the formulation since it can react with the reactive components of the formulation. A linear polydimethylsiloxane bonding layer can be formed from polymerizing dimethyldimethoxysilane from a surface of a substrate. Mineral oils or plant oils can fully wet and stably adhere to a bonding layer including an array of alkyl silanes which can be formed from alkyltrichlorosilanes or alkyltrimethoxysilanes. The alkyl groups on such alkylsilanes can have various chain lengths, e.g., alkyl chains of C₁₋₃₀.

Other lubricants that will be compatible with bonding layers composed of alkylsilanes with various chain lengths and polysiloxanes polymerized from one or more dialkyldialkoxysilanes such as dimethyldimethoxysilane include, for example, alkane oils, and plant oils such as a vegetable oil, avocado oil, algae extract oil, olive oil, palm oil, soybean oil, canola oil, castor oil, rapeseed oil, corn oil, peanut oil, coconut oil, cottonseed oil, palm oil, safflower oil, sesame oil, sunflower seed oil, almond oil, cashew oil, hazelnut oil, macadamia oil, Mongongo nut oil, pecan oil, pine nut oil, peanut oil, walnut oil, grapefruit seed oil, lemon oil, orange oil, amaranth oil, apple seed oil, argan oil, avocado oil, babassu oil, ben oil, borneo tallow nut oil, cape chestnut oil, carob pod oil, camellia seed oil, cocoa butter, cocklebur oil, cohune oil, grape seed oil, Kapok seed oil, Kenaf seed oil, Lallemantia oil, Marula oil, Meadowfoam seed oil, macadamia nut oil, mustard oil, Okra seed oil, papaya seed oil, Pequi oil, poppyseed oil, pracaxi oil, prune kernel oil, quinoa oil, ramtil oil, rice bran oil, rapeseed oil, sesame oil, safflower oil, Sapote oil, Shea butter, squalene, soybean oil, tea seed oil, tigernut oil, tomato seed oil, liquid terpenes, and other similar bio-based oils or synthetic oil, e.g., polycitronellol acetate etc. The plant-based oils can be used alone or with other lubricants or as a mixture of plant-based oils alone or with other lubricants.

Useful fragrances, i.e., a substance that emits a pleasant odor, and/or a masking compound, that can be included in the formulation of the present disclosure include, for example, a natural or synthetic aroma compound or an essential oil such as a lemon oil, bergamot oil, lemongrass oil, orange oil, coconut oil, peppermint, oil, pine oil, rose oil, lavender oil or any combination of the foregoing. As an example, the fragrance added to the formulation of the present disclosure can have a smell of lemon, or rose, or lavender, or coconut, or orange, or apple, or wood, or peppermint, etc. One or more fragrance or masking compound can be added to a formulation of the present disclosure as is, e.g., without dilution, and can be added in a range of about 0.0005 parts to about 10 parts, e.g. from about 0.01 to about 5 parts, by weight. In certain aspects, the fragrance and/or masking compound is soluble in alcohols and siloxanes.

Repellent coatings prepared from formulations of the present disclosure can repel and resist adherence of broad range of liquids and solids including but not limited to water, ice, soapy water, hard water, minerals, plastics, debris, bacteria, residues, such as residue from food stuffs, dairy products, ionic solutions such as phosphate-buffered saline, proteins, fats, yeast, cells, biological fluids, urine, feces, blood, etc.

In practicing certain aspects of the present disclosure, it is preferable to form a repellent coating on a substrate with a relatively smooth surface. In some embodiments, the substrate surface has an average roughness (Ra) at a microscale level, e.g., Ra of less than a few microns, and preferably less than a few hundred nanometers, or even less than a few nanometers. Advantageously, the surface of a substrate to which a repellent coating is to be formed thereon is relatively smooth, e.g., the surface has an average roughness Ra of less than about 4 μm, e.g., less than about 2 μm and less than about 1 μm average surface roughness and even less than about 500 nm, e.g., less than about 100 nm, 80 nm, 60 nm, 40 nm 20 nm, 10 nm, etc. average surface roughness.

Average surface roughness can be measured by atomic force microscope (AFM) using tapping mode with a scanning area of 2×2 μm² for measuring average surface roughness in a 0.1-nanometer scale or equivalent technique. Average surface roughness can be measured by Zygo optical profilometer with an area of 100×100 μm² to 500×500 μm² for measuring average surface roughness in a 1-nanometer scale or equivalent technique.

In practicing certain aspects of the present disclosure, the surface of the substrate can be treated to form reactive groups thereon such as hydroxyl groups, such as by applying and removing an alcohol, by oxygen plasma treatment, or by heating under the presence of air or oxygen (for the case of metals). The substrate can include a reactive coupling layer and the repellent coating formed on the surface of the coupling layer.

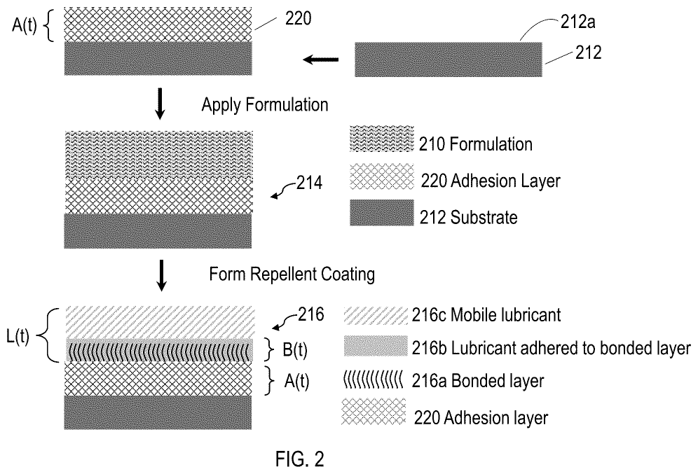

FIG. 2 illustrates another process of forming a repellent coating on a surface of a substrate in accordance with an aspect of the present disclosure. For this example, an adhesion layer 220 is first formed on a surface 212a of the substrate 212 having a certain thickness (A(t)). Adhesion layers can facilitate forming a covalent bonded layer on the surface of the adhesion layer particularly when the adhesion layer has exposed hydroxyl groups. Such adhesion layers can be prepared from alkoxysilane having three or more alkoxy groups such as tetraethyl orthosilicate (TEOS), 1,2-bis(triethoxysilyl)ethane (BTESE), methyltriethoxysilane (MTEOS), Tetramethyl orthosilicate (TMOS), Tetrabutoxysilane (TBOS). Other examples of adhesion layer include (3-aminopropyl)triethoxysilane (APTES). Such adhesion layers can further act as an insulator or dielectric layer on the surface of the substrate.

A formulation (210) of the present disclosure can then be applied to a surface of the adhesion layer (220) to form a repellent coating (216) having a bonded layer 216a with a certain thickness (B(t)) covalently bound to the surface of the adhesion layer (220) with a lubricant layer on the bonded layer (216b, 216c) The lubricant layer can have a certain thickness (L(t)).

The substrate surface can be cleaned and dried before applying a formulation of the present disclosure. One example for cleaning a substrate surface involves the use of a lower alcohol, e.g., ethanol or isopropanol, to rinse the surface. Then the surface can be dried and the formulation applied.

Processes for preparing a repellent coating on a surface of a substrate includes applying a formulation of the present disclosure on a surface of a substrate and causing the reactive components to form a bonded layer on the surface of the substrate. The reactive components are chosen such that they react with the surface to form an array of compounds each having one end bound to the surface and an opposite end extending away from the surface. The lubricant of the formulation is selected such that it has an affinity for the bonded layer and/or surface so that it can form a lubricant layer stably adhered to the surface via the bonded layer.

Repellent coatings on a surface of a substrate can advantageously be formed under relatively low temperatures, e.g., temperatures ranging from about 0° C. to about 80° C. Hence, forming the repellent coating from formulations of the present disclosure can be carried out at from about 5° C. to about room temperature, e.g., 20° C., and at an elevated temperature, e.g., greater than about 25° C., 30° C., 40° C., 50° C., 55° C., 60° C., 70° C., 80° C., etc. Forming the repellent coating can also be advantageously carried out in a relatively short period of time such as in a period of no more than about 120 minutes such as 60 minutes, e.g., no more than about 30 minutes, and no more than 20 minutes, and no more than 10 minutes, and even as short a period of no more than about 5 minutes. Applying the formulation of the present disclosure and forming the repellent coating can be carried out in air at atmospheric pressure with relative humidity between 10% to 80% at temperatures from about 5° C. to about 75° C.

Applying formulations of the present disclosure on to a surface of a substrate can be carried-out with liquid-phase processing thereby avoiding complex equipment and processing conditions. Such liquid-phase processing includes, for example, simply submerging the substrate (dip-coating) or applying the formulation on to the substrate surface by wiping, spraying (including aerosol spray), curtain coating, slot die coating, Gravure coating, roll coating, and/or spin coating the formulation on to the surface. Other methods of applying formulations of the present disclosure on to a surface of a substrate can be carried out by wiping a towel made of a fabric, paper or similar material, or a sponge or squeegee, infused with the formulation, on the surface to transfer the formulation from the towel, sponge, squeegee to the surface of the substrate. Advantageously, the formulation can be applied to the substrate surface under ambient temperatures and/or atmospheric pressures and in air, e.g., formulations of the present disclosure can be applied on surfaces of substrates in air and at atmospheric pressure. The formation of the bonded layer is accelerated in the presence of the acid catalyst and moisture or water. The water can be either available from the formulation or from the atmosphere or both. Applying the formulation in an atmosphere having some moisture, e.g., an ambient humidity of at least about 10% at 20° C. and atmospheric pressure is preferable for certain of the reactive components. Hence in some embodiments, the formulation of the present disclosure is applied at an ambient humidity of from about 10% to no more than about 80%.

In some instances and under certain conditions, the lubricant layer of a repellent coating can be depleted over time. Advantageously, the lubricant layer can be replenished by applying lubricant, either the same or a different lubricant than used to prepare the repellent coating, to the bonded layer to renew the repellent coating system on the surface of the substrate. The applied lubricant can be in undiluted form when applied to the bonded layer or diluted with a medium when applied to the bonded layer. The medium can include water, one or more of a lower ketone, e.g., a C₁₋₈ ketone such as acetone, methyl ethyl ketone, cyclohexanone, a lower alcohol, e.g., a C₁₋₈ alcohol such as methanol, ethanol, isopropanol, a butanol, a lower ether, e.g., a C₁₋₈ ether such as dimethyl ether, diethyl ether, tetrahydrofuran, a lower ester, e.g., a C₁₋₈ ester such as ethyl acetate, butyl acetate, glycol ether esters, a lower halogenated solvent, e.g., a chlorinated C₁₋₈ such as methylene chloride, chloroform, an aliphatic or aromatic hydrocarbon solvent such as hexane, cyclohexane, toluene, xylene, dimethylformamide, dimethyl sulfoxide and any combination thereof. The medium can also include or consist of a volatile organic compound exempt solvent. Such a medium can include, for example, a linear or a branched volatile methyl siloxane solvent. Such solvents include, for example, linear volatile methyl siloxanes such as dimethyl silicones and siloxanes, e.g., hexamethyldisiloxane, octamethyltrisiloxane, decamethyltetrasiloxane, dodecamethylpentasiloxane, etc. and branched volatile methyl siloxane solvents such as 1,1,1,3,5,5,5-Heptamethyl-3-[(trimethylsilyl)oxyl]-trisiloxane, 1,1,1,5,5,5-Hexamethyl-3,3,-bis[(trimethylsilyl)oxy]-trisiloxane, Pentamethyl[(trimethylsilyl)oxy]-cyclotrisiloxane.

The lubricant can be diluted in the medium in which the medium comprises from about 1 wt % to about 99.9 wt % of a mixture of the medium with the lubricant. The range of dilution can depend on the medium. For example, a water medium can be used from about 1wt % to about 99.9 wt % and an alcohol medium such as isopropanol can be used from about 1 wt % to about 99.9 wt %. The lubricant can be applied to the bonded layer, undiluted or diluted, and by dip-coating, wiping, spraying (including aerosol spray), etc.

An exemplary formulation of the present disclosure can include one or more polymerizable silane monomers and/or siloxane monomers as the reactive component, an acid catalyst, e.g., nitric acid, hydrochloric acid, phosphoric acid. After applying the formulation to a substrate, the monomers polymerize from exposed hydroxyl groups on the surface of the substrate to form an array of linear polysilanes or polysiloxanes or a combination thereof. By this technique, the array of linear polymers has ends covalently bound to the surface and opposite ends extending away from the surface and resemble a brush.

Advantageously, the formulations of the present disclosure can be applied to surfaces of ceramic or metal toilets, showers, sinks, urinals, plumbing fixtures, surfaces of glass substrates including mirrors, windshields, windows in a building, a glass optical lens for a camera, surfaces composed of one or more polymers such as plastic sinks, showers, toilets, urinals, surfaces of personal protective equipment such as gowns, face shields goggles, shoe covering and shoes and medical devices such as ostomy appliances, catheters, contact lenses, syringe, scalpel, endoscope lens, metal and plastics implants (e.g., orthopedic implants, dental implants, glaucoma implants), prostheses, etc.; automobile parts such as windshields, camera lens, lamp and sensing casings, mud flaps, car bodies; airplane parts such as windshield, airplane wings and bodies; marine parts such as submerged devices, cables, ships and boats; outdoor and indoor signage, bus step enclosures.

Many medical devices can benefit from the formulations and repellent coatings of the present disclosure including medical devices composed of polymeric surfaces. For example, an ostomy appliance (bag or pouch as they are commonly referred) can include a collection pouch and one or more ports including one or more outlet ports. Such ostomy appliances have surfaces typically made of one or more polymers that can be coated with formulations of the present disclosure to form one or more repellent coated surfaces. Another example is a medical catheter used to transport or drain body fluids such as blood, urine, cerebrospinal fluid. These catheters are made from polymeric materials such as silicone, polyurethane, polyolefin, polyvinyl chloride, and these materials can be coated with formulations of the present disclosure to form one or more repellent coated surfaces.

In an implementation of the present disclosure, a formulation including (i) one or more reactive components that can form a bonded layer on a surface; (ii) an acid catalyst; and (iii) a lubricant can be applied to a surface of a polymeric film, such as a multilayer polymeric film that can be used to form a medical device such as an ostomy appliance. As explained in the present application, the one or more reactive components that can form a bonded layer on a surface and the lubricant can substitute for a solvent, diluent, or carrier in the formulation and can be included in the formulation in high concentration. The formulation can be applied, such as by a slot die, on the film in a roll-to-roll process to form a repellent coated polymeric film with high throughput. In addition, the surface of the polymeric film can be treated to form reactive groups such as hydroxyl groups on the surface, such as by subjecting the film surface to an oxygen or air plasma or corona discharge and/or by applying and removing an alcohol, prior to applying formulations of the present disclosure. The films having the repellent coating can then be used to fabricate an ostomy appliance. Alternatively, or in addition, a formulation of the present disclosure can be applied to a surface of an ostomy appliance, e.g., an inner surface, to form the repellent coating.

In addition, many electrical and electronic components and devices can benefit from the formulations and repellent coatings of the present disclosure including semiconductor components, printed circuit boards, microfluidic devices, digital microfluidic devices, electrowetting on dielectric (EWOD) devices. Such components and devices can have surfaces composed of electrically conductive materials, semiconductor materials, dielectric materials, insulators, etc. such as metals and alloys thereof, conducting metal oxides such as indium tin oxide, doped and undoped silicon, gallium, ceramics, glasses, silicon dioxide, silicon nitride, aluminum oxide, epoxy-based resin, such as a novalac epoxy, etc.

In one implementation of the present disclosure, a microfluidic device, such as an electrowetting on dielectric (EWOD) device, can include a repellent coating prepared from a formulation including (i) one or more reactive components that can form a bonded layer on a surface; (ii) an acid catalyst; and (iii) a lubricant. Such a formulation can be applied to a surface of the device or a component used to fabricate such a device. Microfluidic devices can process small amounts of fluids in the form of droplets to screen or otherwise analyze the fluid. Repellent coatings of the present disclosure can advantageously be used on surfaces of microfluidic devices to reduce adhesion of fluid samples and further to resist fouling of the surfaces, which can be problematic when the microfluidic device is configured to process biological fluid samples. Biological fluids, e.g., mammalian biological fluids, include whole blood, serum, plasma, saliva, nasopharyngeal fluid, cerebrospinal fluid, semen, vaginal fluids, mucus, and urine and often contain components, such as DNA, RNA, proteins, lipids, cells, that can foul surfaces. Repellent coatings of the present disclosure can advantageously be formed on a surface of a microfluidic device, e.g., an electrically conducting surface, on a dielectric layer surface, and/or on an insulating surface, to reduce adhesion and fouling of such surfaces.

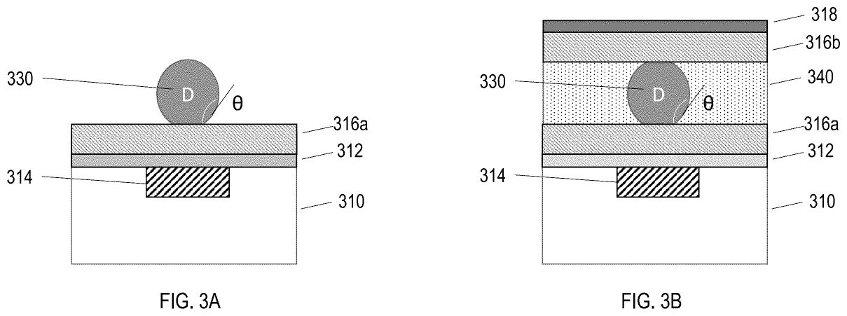

As an example, FIGS. 3A and 3B illustrate repellent coatings on microfluidic EWOD devices. As shown in the figures, an EWOD device can include substrate 310, electrode 314, a dielectric layer 312 on the electrode 314 and a repellent coating 316a on the dielectric layer 312. A sample droplet (330), such as a biological fluid sample, can be processed over the repellent coating 316a. Processing of the sample can include transporting, dividing, etc. the sample over the surface and combining the sample with reagents and/or components such as reagents and/or components useful for screening and/or analyzing a biological fluid sample.

The substrate 312 can be composed of an insulator such as a glass, the electrode 314 can be composed of an electrically conductive material such as a metal, metal alloy, electrically conducting metal oxide such as indium tin oxide, etc. and the dielectric layer can be composed of dielectric materials such as a ceramic, silicon nitride, silicon dioxide, aluminum oxide, etc. The repellent coating (316a) can be formed on the dielectric layer by applying a formulation of the present disclosure. Further, the thickness of the lubricant layer can be adjusted to reduce fouling of the surface when exposed to a sample droplet (330). For example, the lubricant can have a thickness from the surface of the dielectric layer of at least about 1 micron and higher, e.g., up to 2, 4, 5, 6, 7, 8, 9, 10, 15, 20, 30, 40, 50 microns or more.

FIG. 3B further illustrates a closed EWOD device which includes an electrically conductive layer 318 above the droplet (330). Advantageously, a repellent coating (316b) can be formed on the electrically conductive layer 318 to contact the droplet 330. In addition, the repellent coating (316b) can be formed on a dielectric layer on the surface facing the droplet of the electrical layer (318) if such a layer is used in the device (not shown for illustrative convenience). With a closed EWOD device, the device can include a medium (340) other than air in the space that processes the droplet. Such a medium can include a mineral oil, silicon oil, perfluorinated oil, or other media.

The following examples are intended to further illustrate certain aspects of the subject technology and are not limiting in nature. Those skilled in the art will recognize, or be able to ascertain, using no more than routine experimentation, numerous equivalents to the specific substances and procedures described herein.

### EXAMPLES

### Example 1: Low VOC Formulations and Stability

The following formulations were prepared and tested for shelf-life stability. The testing included sliding angle measurements using water droplets.

TABLE 1
Low VOC Repellent Formulations

| | | Dimethyl | | | Shelf |
|---|---|---|---|---|---|
| | Lubricant | dimethoxy silane | | ^{‡}Acid | life |
| No. | (vol %) | (vol %) | | (vol %) | (days) |
| A1 | ^{†}PDMS 5 cSt | | 2% | Nitric acid | >50 d |
| | (97%) | | | (1%) | |
| A2 | PDMS 5 cSt | ^{††} | 0% | Nitric acid | >50 d |
| | (99%) | | | (1%) | |
| A3 | PDMS 20 cSt | | 2% | Nitric acid | >35 d |
| | (97%) | | | (1%) | |
| A4 | PDMS 350 cSt | | 2% | Nitric acid | >20 d |
| | (97%) | | | (1%) | |
| A5 | PDMS 5 cSt | | 2% | Sulfuric acid | >20 d |
| | (97%) | | | (1%) | |
| A6 | PDMS 5 cSt | ^{††} | 0% | Sulfuric acid | >20 d |
| | (99%) | | | (1%) | |
| A7 | PDMS 20 cSt | | 2% | Sulfuric acid | >20 d |
| | (97%) | | | (1%) | |
| A8 | PDMS 350 cSt | | 2% | Sulfuric acid | >20 d |
| | (97%) | | | (1%) | |
| A9 | hydroxyl silicone oil 25 | | 2% | Nitric acid | >20 d |
| | cSt (97%) | | | (1%) | |
| A10 | PDMS 5 cSt | ^{†††} | 2% | Hydrochloric | — |
| | (97%) | | | acid | |
| | | | | (1%) | |

^{†}PDMS refers to a polydimethylsiloxane (silicone oil).
^{††} Formulations without the reactive component (A2 and A6) did not form a bonded layer and the lubricant was readily removed.
^{†††} Formulation A10 took about one hour to form a repellent coating and was thus not tested for shelf-life stability.
^{‡} The formulations were prepared using the listed acids with the following approximate concentrations in water: 70% nitric acid, 95% sulfuric acid and 37% HCl.

The data in Table 1 above shows that formulations including a reactive component, acid catalyst and lubricant can be shelf stable for over one month and form repellent coatings after the storage periods. Formulations indicated with a shelf life greater than a certain number of days produced repellent coatings and had sliding angles that did not change significantly over the storage period. Further, the formulations can include over 95% lubricant based on the total weight of the formulation.

Formulations A2 and A6, which did not include a reactive component, e.g., dimethyl dimethoxy silane, did not produce a bonded layer and the lubricant was readily removed from the surface.

The above working formulations can be applied onto glass, ceramic, inorganic oxides (e.g., silicon dioxide) and metal oxides surfaces. Formulation A3 was tested on high density polyethylene (HDPE), EVA (ethylene-vinyl acetate), and polyvinyl chloride (PVC) and produced a repellent coating on such substrates.

### Example 2: Repellent Coating for Electronic Devices

An adhesion layer was applied to materials that are commonly used with electronic and microfluidic devices such as silicon, silicon nitride and an indium tin oxide substrate. An adhesion layer can serve the dual purpose of improving adhesion of the repellent coating on the substrate and also to increase the dielectric strength or the breakdown voltage of the repellent coating layer.

### Example 2.1: Repellent Coating on Adhesion Layer on Silicon

A substrate composed of silicon was cleaned with isopropyl alcohol (IPA) and dried with lint free wipes and then subjected to a plasma treatment which included exposure for about 5 minutes with 30 W RF power and 300 mTorr vacuum. The silicon substrate was then dip coated in a solution including isopropyl alcohol, 1,2-bis(triethoxysilyl)ethane, and acetic acid having volume ratio of 20:2:1. The dip coated silicon substrate was then subjected to a temperature of 110° C. for 10 minutes to cure the 1,2-bis(triethoxysilyl)ethane to form a crosslinked organosilica adhesion layer on the surface of the silicone substrate. A repellent coating was formed on the adhesion layer by spray coating or dip coating the substrate with adhesion layer with a formulation including sulfuric acid, dimethyldimethoxysilane, 20 cSt silicone oil and isopropyl alcohol with volume ratios of 1:5:5:100. The coating is ready to use after rinsing with deionized (DI) water. The formulation applied for these experiments included a low concentration of lubricant (<10 wt %) to demonstrate forming repellent coatings on an adhesion layer. Formulations with a high concentration of lubricant (>50 wt %) can also be used.

### Example 2.2: Repellent Coating on Adhesion Layer on Silicon Nitride

The same procedure was used to form a repellent coating on an adhesion layer on a substrate composed of silicon nitride as described for the silicon substrate above.

### Example 2.3: Repellent Coating on Adhesion Layer on ITO

The same procedure was used to form a repellent coating on an adhesion layer on a substrate composed of indium tin oxide as described for the silicon substrate above.

### Example 2.4: Adjusting Thickness of Adhesion Layer

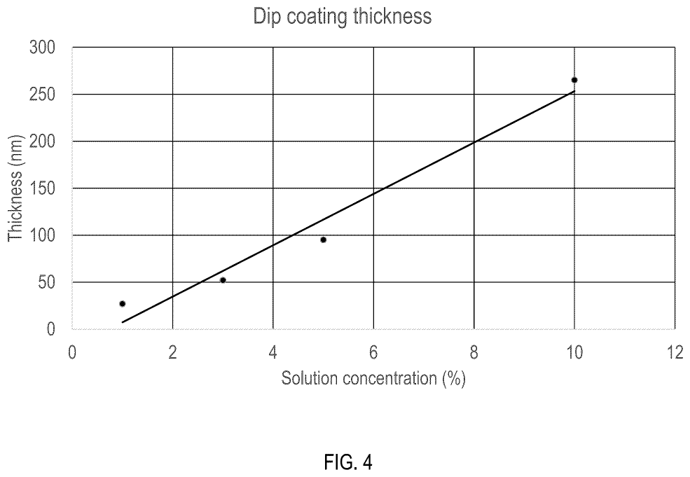

The adhesion layer thickness can be adjusted by adjusting the concentration of the bis(triethoxysilyl)ethane in a solution with it, solvent and acid. For example, by maintaining a solution having isopropyl alcohol and acetic acid with volume ratio of 20:1 and adjusting the amount of bis(triethoxysilyl)ethane in the solution, the thickness of the adhesion layer can be adjusted. In a series of experiments, a substrate was dip coated with such a bis(triethoxysilyl)ethane solution followed by curing at 110° C. for 10 minutes to form the adhesion layer. Then a repellent coating was formed on the adhesion layer by dip coating the substrate with adhesion layer in a formulation including sulfuric acid, dimethyldimethoxysilane, 20 cSt silicone oil and isopropyl alcohol with volume ratios of 1:5:5:100. The withdrawal speed in dip coating is constant at 1 mm/s. The thickness was quantified using a M-2000XF Woollam spectroscopic ellipsometer. The thickness of the bonded layer was about 4-10 nm while the thickness of the adhesion layer was adjusted from about 20 nm to about 300 nm. FIG. 4 is a plot of the combined thickness of the bonded layer and adhesion layer versus the concentration of bis(triethoxysilyl)ethane in the solution forming the adhesion layer. As shown by the plot in FIG. 4, the thickness of the adhesion layer can be readily adjusted.

### Example 2.5: Repellent Coating Directly on Silicon, Silicon Nitride and ITO

A repellent coating according to aspects of the present disclosure can also be formed directly on substrate surfaces without an adhesion layer. The following repellent coatings were prepared from the following formulations. (The formulation applied for these experiments included a low concentration of lubricant to demonstrate forming repellent coatings directly on substrate surfaces. Formulations with a high concentration of lubricant can also be used.)

Silicon: A substrate composed of silicon was cleaned with IPA and dried with lint free wipes and then subjected to a plasma treatment which included exposure for about 5 minutes with 30 W RF power and 300 mTorr vacuum. A repellent coating was formed directly on the plasma treated silicon by dip coating the substrate in a formulation including hydrochloric acid, dimethyldimethoxysilane, 20 cSt silicone oil and isopropyl alcohol with volume ratios of 1:5:5:100. The repellent coating is ready to use after rinsing with deionized (DI) water. Additional silicone lubricant (20 cSt silicone oil) was applied (by wiping) to the substrate with the bonded layer to adjust the thickness of the lubricant layer.

Silicon Nitride (Si₃N₄): A substrate composed of silicon nitride was cleaned with IPA and dried with lint free wipes and then subjected to plasma treatment for 5 minutes with 30 W RF power and 300 mTorr vacuum. A repellent coating was formed directly on the plasma treated silicon nitride substrate by dip coating the substrate in a formulation including hydrochloric acid, dimethyldimethoxysilane, 20 cSt silicone oil and isopropyl alcohol with volume ratios of 1:5:5:100. The repellent coating is ready to use after rinsing with DI water. Additional silicone lubricant (20 cSt silicone oil) was applied (by wiping) to the substrate with the bonded layer to adjust the thickness of the lubricant layer.

Indium Tin Oxide (ITO): A substrate composed of indium tin oxide was cleaned with IPA and dried with lint free wipes and then subjected to plasma treatment for 40 minutes with 30W RF power and 300 mTorr vacuum. A repellent coating was formed directly on the plasma treated ITO substrate by dip coating the substrate in a formulation including hydrochloric acid, dimethyldimethoxysilane, 20 cSt silicone oil and isopropyl alcohol with volume ratios of 1:5:5:100. The repellent coating is ready to use after rinsing with DI water. Additional silicone lubricant (20 cSt silicone oil) was applied (by wiping) to the substrate with the bonded layer to adjust the thickness of the lubricant layer.

### Example 2.6: Wettability of Repellent Coating

The wettability of substrates with and without a repellent coating according to the present disclosure were compared. The wettability of the fluorinated hydrocarbon coatings on a substrate was also compared. The comparative data were determined on the following substrates: Si3N4 (uncoated), Si3N4 (RC) (prepared according to Example 2.5), ITO (uncoated), ITO (RC) (prepared according to Example 2.5) and a Si3N4 (RC, 100 nm) coated substrate.

The Si3N4 (RC, 100 nm) coated substrate was prepared by initially forming an adhesion layer on a silicon nitride substrate. The substrate was cleaned and dried and then subjected to a plasma treatment for 5 minutes with 8 W RF power and 300 mTorr vacuum. The substrate was then dip coated in a solution including isopropyl alcohol, 1,2-Bis(triethoxysilyl)ethane and acetic acid with volume ratio of 18:1:1 followed by subjecting the dip coated substrate to a temperature of 110° C. for 10 minutes to cure the 1,2-bis(triethoxysilyl)ethane to form a crosslinked organosilica adhesion layer on the surface of the silicone substrate having a thickness of about 100 nm. A repellent coating was formed on the adhesion layer by applying a formulation including sulfuric acid, dimethyldimethoxysilane, 20 cSt silicone oil and isopropyl alcohol with volume ratios of 1:5:5:100. The repellent coating is ready to use after rinsing with DI water.

Wettability data were collected with a Data physics OCA 11 goniometer. Contact angles (CA) were measured with 10 μL water droplets, while contact angle hysteresis (CAH) and sliding angles (SA) were measured with 20 μL water droplets. The wettability characteristics were determined in mineral oil using a quartz cell (45×30×45 mm). Substrates were placed in the bottom of the cell and then covered with mineral oil. Then a water droplet was deposited on the substrate via a needle and CA, CAH and SA measurements determined.

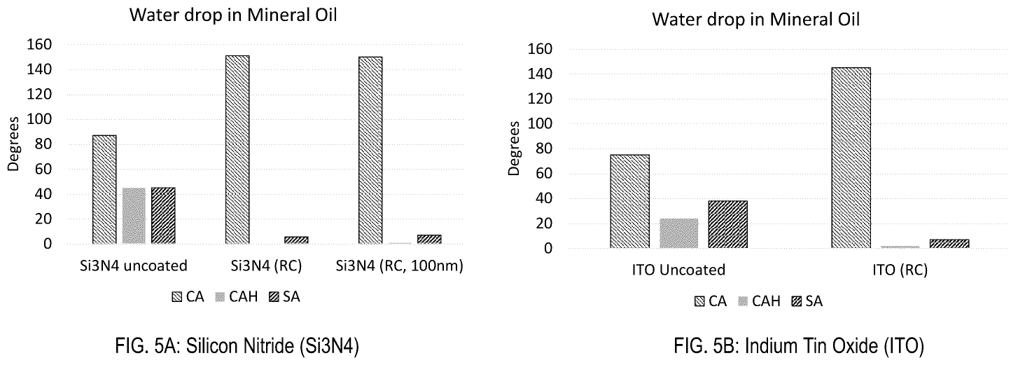

FIGS. 5A and 5B show wettability characteristics of the various substrates in mineral oil with a water droplet. As shown in the figure, wettability characteristics of substrates composed of silicon nitride and indium tin oxide (uncoated) were compared to substrates having a repellent coating. As shown in FIGS. 5A and 5B, repellent coatings according to aspects of the present disclosure had significantly better (higher) contact angles (CA) compared to uncoated substrates and significantly better (lower) contact angle hysteresis (CAH) and sliding angle (SA) contact angles compared to uncoated substrates.

### Example 2.7: Biofouling Resistance of Repellent Coatings

Experiments were conducted to show antifouling characteristics of repellent coatings of the present disclosure. Fluorescent labeled protein Bovine Serum Album (BSA) (Albumin-fluorescein isothiocyanate conjugate) was dissolved in phosphate buffered solution (PBS) to form a 0.1 wt % protein solution. Substrates with and without coatings were submerged in the protein solution for 5 minutes. Then the substrates were removed from the protein solution and imaged on a Zeiss AxioImager fluorescence microscope. The fluorescence intensity and coverage data was then generated in ImageJ. High fluorescence intensity means high protein fouling on the substrates. The results along with intensity reduction compared with an uncoated substrate are listed in Table 2.

TABLE 2
BSA protein fluorescence signal on uncoated/coated
substrates because of biofouling

| | Intensity | % Reduction over |
|---|---|---|
| | (arb. unit) | Si3N4 (uncoated) |
| Si3N4 | 840 ± 290 | NA |
| (uncoated) | | |
| Si3N4 (RC) | 2.6 ± 2.3 | 99 ± 0.0 |

Si3N4 (RC) is a silicon nitride substrate with a repellent coating prepare according to Example 2.5 with additional lubricant to form a bonded layer with 1 μm thick lubricant layer.

The data show that a substrate having a repellent coating according to one or more implementations of the present disclosure can reduce protein fouling of the surface by over 90% compared to an uncoated substrate.

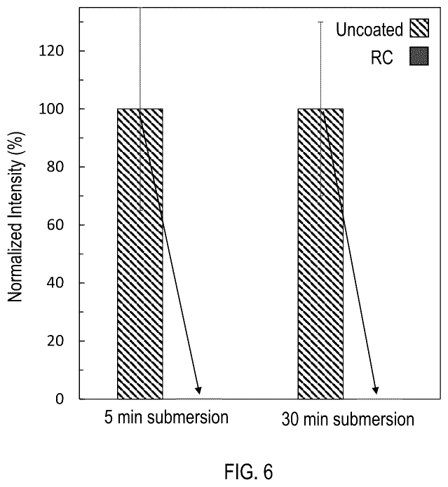

FIG. 6 further illustrates antifouling characteristics of a repellent coating of the present disclosure. FIG. 6 shows data comparing protein fouling for an uncoated substrate (uncoated), a substrate having a repellent (RC) coating in accordance with one or more implementations of the present disclosure.

Such high antifouling characteristics of a repellent coating of the present disclosure is advantageous for devices that manipulate and/or process biological fluid samples such as diagnostic microfluidic devices and/or EWOD devices.

### Example 2.8: Biofouling Resistance of Repellent Coatings and Lubricant Thickness

Experiments were conducted to determine whether lubricant thickness can influence antifouling of repellent coatings of the present disclosure. Repellent coatings were prepared on clean ITO substrates following the procedure described in Example 2.5.

The thickness of the lubricant on the coated substrates can be adjusted by applying a known amount of lubricant (by pipetting or by wiping with non-absorbing material) to the substrate. The thickness of the lubricant can also be determined by measuring the weight change of a substrate before and after applying the formulation to form the repellent coating and considering the known density of the lubricant and coated surface area to calculate thickness. For example, 100 μL (0.095 gram) 20 cSt lubricant at a density of about 0.95 g/cm³ and covering a wetted surface area of 10×10 cm² would yield a lubricant thickness of approximately 10 μm.

ITO substrates with repellent coating of different lubricant thicknesses were then tested with a protein rich sample droplet and a phosphate buffered saline (PBS) droplet in air to determine the sample's wettability characteristics. A protein rich cell culture medium was prepared from the Endothelial Growth Mediums-2 kit (EGM-2) available from Lonza Bioscience. In contrast, PBS is a widely used cell culture reagent that does not contain protein. Wettability data were collected with a Data physics OCA 11 goniometer in which Contact angles (CA) were measured with 10 μL water droplets, while contact angle hysteresis (CAH) and sliding angles (SA) were measured with 20 μL water droplets. The wettability results are provided in Tables 3 and 4 below.

TABLE 3
Wettability of PBS droplets (in air) on substrates with
repellent coating having different lubricant thickness

| Lubricant | | | |
|---|---|---|---|
| Thickness | CA | CAH | SA |
| (μm) | (Degrees) | (Degrees) | (Degrees) |
| 1.1 | 108.68 ± 2.15 | 0.59 ± 0.25 | 2.00 ± 0.00 |
| 5 | 105.49 ± 1.08 | 1.16 ± 0.31 | 2.33 ± 0.52 |
| 10 | 100.91 ± 1.00 | 0.98 ± 0.07 | 2.00 ± 0.00 |
| 22 | 103.48 ± 1.33 | 0.97 ± 0.47 | 1.67 ± 0.82 |

TABLE 4
Wettability of cell culture medium droplets (in air) on substrates
with repellent coating having different lubricant thickness

| Lubricant | | | |
|---|---|---|---|
| Thickness | CA | CAH | SA |
| (μm) | (Degrees) | (Degrees) | (Degrees) |
| 1.1 | 97.39 ± 2.48 | 8.55 ± 3.06 | 10.17 ± 3.06 |
| 5 | 98.24 ± 1.15 | 3.71 ± 2.28 | 5.00 ± 2.76 |
| 10 | 93.29 ± 2.76 | 1.33 ± 0.14 | 2.00 ± 0.00 |
| 22 | 94.19 ± 2.83 | 1.43 ± 0.73 | 2.50 ± 0.84 |

As shown by the data in Table 3, the lubricant thickness did not significantly change the wettability characteristics of the repellent coating to a PBS solution from a thickness of greater than 1 micron to 22 microns. However, when testing a protein rich aqueous sample, the thickness of the lubricant significantly influenced the wetting characteristics of the sample. As shown by the data of Table 4, a repellent coating having a lubricant thickness of at least 5 microns significantly lowered the sliding contact angle (SA) and improved the contact angle hysteresis (CAH) relative to a repellent coating with lower lubricant thicknesses. The data show that repellent coatings of the present disclosure with lubricant thickness of at least about 5 microns can further reduce fouling of proteins and other hydrophobic materials such as those contained in biological fluids.

Only certain features and aspects of the subject technology and examples of its versatility are shown and described in the present disclosure. It is to be understood that the technology disclosed herein is capable of use in various other combinations and environments and is capable of changes or modifications. Thus, for example, those skilled in the art will recognize, or be able to ascertain, using no more than routine experimentation, numerous equivalents to the specific substances, procedures and arrangements described herein. Such equivalents are considered to be within the scope of the invention, and are covered by the following claims.

What is claimed is:

1. A formulation for forming a repellent coating, the formulation comprising:
(i) one or more reactive components that can form a bonded layer on a surface in which the bonded layer comprises an array of compounds each compound having one end bound to the surface and an opposite end extending away from the surface;
(ii) an acid catalyst; and
(iii) a lubricant;
wherein the lubricant comprises more than 50 wt % of the total weight of the formulation and wherein the lubricant has a viscosity of at least about 2 cSt as measured at 25° C.

2. The formulation of claim 1, wherein the one or more reactive components are one or more dialkyl di-alkoxy silanes and the lubricant comprises a silicone oil or a mineral oil or a plant oil or any combination thereof.

3. The formulation of claim 1, wherein the lubricant has a viscosity of at least about 15 cSt as measured at 25° C.

4. The formulation of claim 1, wherein the lubricant comprises more than 80 wt % of the total weight of the formulation.

5. A process of forming a repellent coating on a surface of a substrate from a formulation according to claim 1, the process comprising:
applying the formulation on a surface of a substrate to form the repellent coating including a bonded layer on the surface and a lubricant layer stably adhered to the bonded layer.

6. The process of claim 5, wherein the formulation is applied in air and at atmospheric pressure.

7. The process of claim 5, further comprising treating the surface of the substrate with an oxygen or air plasma to generate hydroxyl groups on the surface of the substrate followed by applying the formulation on the surface to form the repellent coating on the surface.

8. The process of claim 5, further comprising forming an adhesion layer on the substrate surface and applying the formulation on a surface of the adhesion layer to form the repellent coating on the surface of the adhesion layer.

9. The process of claim 5, wherein the surface of the substrate comprises glass, porcelain, silicon, a semiconductor, ceramic, silicon nitride, silicon dioxide, aluminum oxide, indium tin oxide, a metal and/or a polymer.

10. The process of claim 5, wherein the substrate is a medical device.

11. A microfluidic device, comprising
a substrate surface and a repellent coating on the surface of the substrate; wherein the repellent coating includes a layer bonded on the surface, a lubricant layer on the bonded layer.

12. The microfluidic device of claim 11, wherein the device is configured to process a sample of biological fluid.

13. The microfluidic device of claim 11, wherein the device further includes a dielectric layer on an electrode and wherein the repellent coating is on the dielectric layer.

14. The microfluidic device of claim 11, wherein the device further includes an electrically conducting layer and wherein the repellent coating is on the electrically conducting layer.

15. The microfluidic device of claim 11, wherein the lubricant layer is at least 5 microns in thickness.
